(19) United States
(12) Patent Application Publication
(10) Pub. No.: US 2009/0241394 A1
(43) Pub. Date: Oct. 1, 2009

(54) ELECTRIC STUN DEVICE

(75) Inventor: Benoit Yelle, Lachenaie (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/059,288

(22) Filed: Mar. 31, 2008

(51) Int. Cl. F41C 9/00; H01T 23/00

(52) U.S. Cl. 42/1.08; 361/232

(57) ABSTRACT

A method for controlling discharge of an electric stun device and an electric stun device. Status information is obtained from at least a second electric stun device via a wireless interface and a decision is taken, considering the status information, indicating if it is proper to discharge the electric stun device. An electric stun device comprising a wireless network interface capable of receiving authoritative information from at least another wireless device and a discharge control module that receives the authoritative information from the wireless network interface assesses whether the authoritative information indicates that the electric stun device is permitted to discharge.

### TECHNICAL FIELD

The present invention relates to an electric stun device and, more precisely, to enhancing an electric stun device with a wireless interface.

### BACKGROUND

The electric stun device is used in many contexts and aims at controlling a target person's behavior without affecting that person's health. It can be used, for instance, by law enforcement groups, private security groups and individuals.

There is currently a perception of insecurity around the electric stun device as many such devices are said to be a potential cause of injuries and even death of the target person. While scientific evidence underlying the allegations is potentially uncertain, it remains that the electric stun device was designed in such a way that, in normal circumstances, a single discharge of a single device shall allow for the expected control of the target person. However, there is no mechanism at the moment that allows for discharge control received by the target person. While it may be unclear whether the number or characteristics of discharges is a factor in potential injuries said to be caused by the electric stun device, better control of the discharges may at least increase public confidence in the device.

Furthermore, with the advent of individual versions of the electric stun device, an interesting question is whether the law enforcement officers are likely to be targeted and unable to conduct their work.

The present invention provides a solution to the above problems of inability to control the discharge received by the target person and further provides a solution to the potential issue of targeted law enforcement officers.

### SUMMARY

A first aspect of the present invention is directed to a method for controlling discharge of an electric stun device. The method comprises the steps of obtaining status information from at least a second electric stun device via a wireless interface of the electric stun device and taking a decision, considering the status information, indicating if it is proper to discharge the electric stun device.

Optionally, the step of obtaining status information may further comprise obtaining status information showing that the second electric stun device has taken an own decision to discharge and the step of taking the decision may further comprise indicating that it is not proper to discharge the electric stun device. Thereafter, the method may also further comprise steps of obtaining further status information from the at least a second electric stun device via a wireless interface of the electric stun device and taking a further decision considering the further status information, indicating if it is proper to discharge the electric stun device.

The step of obtaining status information may optionally further comprise obtaining status information showing that the second electric stun device has taken an own decision to discharge. Then, then method could comprise a further step of negotiating a level of discharge with the second electric stun device via the wireless interface. The step of taking the decision would therefore further comprise indicating that it is proper to discharge the electric stun device at the negotiated level.

The step of obtaining status information may also further comprise obtaining status information showing that the second electric stun device has taken an own decision to discharge. If such is the case, then the method may further comprise obtaining an override command prior to indicating that it is proper to discharge the electric stun device.

Another option for the step of obtaining status information is that it further comprises obtaining status information showing that the second electric stun device is of a superseding type compared to the electric stun device's own type. The step of taking a decision shall therefore comprise indicating that it is not proper to discharge the electric stun device.

The step of taking the decision may optionally further comprise indicating that it is proper to discharge the electric stun device, in which case the method further comprises steps of sending status information from the electric stun device via the wireless interface thereof indicating the decision to discharge and, thereafter, activating discharge of the electric stun device. In such a case, the method may yet further comprise, following the step of activating discharge of the electric stun device, steps of detecting a failure to properly discharge the electric stun device and sending status information from the electric stun device via the wireless interface thereof indicating the discharge has failed.

The method of claim may optionally further comprise a first step of pairing the electric stun device with the at least second electric stun device and a second step of detecting a command to discharge the electric stun device. The step of obtaining status information from the at least second electric stun device via a wireless interface of the electric stun device would thus further comprise receiving the status information from the at least second electric stun device comprising the at least second electric stun device's type and discharge status.

The step of receiving the status information may optionally be preceded by a step of sending a request message for the status information to the at least second electric stun device via the wireless interface.

The method of claim may yet optionally further comprise steps of detecting a malfunction of the electric stun device and, thereafter, deactivating at least a discharge capability of the electric stun device without possibility of override by command.

A second aspect of the present invention is directed to an electric stun device comprising a wireless network interface capable of receiving status information from at least a second electric stun device, a discharge control module that takes a decision, considering the status information, indicating if it is proper to discharge the electric stun device and a discharge module that discharges the electric stun device based on the decision of the discharge control module.

The device may further comprise a command input module that receives a command to discharge and sends the command to discharge to the discharge control module, The discharge control module then takes the decision following reception of the command to discharge.

The discharge control module may optionally further receive, before taking the decision, the status information from the wireless network interface indicating that at least one of the at least second electric stun device has taken an own decision to discharge. The decision then indicates that it is not proper to discharge the electric stun device. Thereafter, and optionally, the command input module may, following the decision, receive a second command to discharge and the discharge control module may take a second decision indicating that it is proper to discharge the electric stun device.

The discharge control module may also further request the status information from at least a second electric stun device via the wireless interface upon reception of the command to discharge and thereafter receives the status information from the wireless network interface.

The discharge control module may also optionally fail to receive, before taking the decision, the status information from the wireless network interface, in which case the decision indicates that it is proper to discharge the electric stun device. The wireless network interface may also be further capable of sending status information to the at least second electric stun device after the decision being taken by the discharge control module.

Optionally, the wireless network interface may be further capable of pairing with the at least second electric stun device.

Yet another option is that the status information received from at least the second electric stun device indicates that at least one of at least the second electric stun device is of an overriding type, wherein the decision indicates that it is not proper to discharge the electric stun device.

A third aspect of the present invention is directed to an electric stun device comprising a wireless network interface capable of receiving authoritative information from at least another wireless device and a discharge control module that receives the authoritative information from the wireless network interface assesses whether the authoritative information indicates that the electric stun device is permitted to discharge.

The discharge control module may optionally assess whether the authoritative information indicates that the electric stun device is permitted to discharge by comparing a device type of the electric stun device with the received authoritative information.

The device type information may be entered in the device before initial use of the device. The device type information may also (or alternatively) be entered in the device using an electronic key. Optionally, the device may further comprise electronic key input port for receiving the electronic key's computer readable media. The device electronic key may alternatively or in addition be entered in the device using the wireless interface. The electronic key can yet also be entered in the device using an interface port also used to charge the device.

The discharge control module's assessment may indicate that the electric stun device is not permitted to discharge and the discharge control module may thereafter prevent discharge of the electric stun device. The discharge control module may optionally prevent discharge by disabling a discharge module.

The device may further comprise a command input module that receives an overriding command that causes the discharge control module to stop preventing discharge of the electric stun device. The overriding command may optionally be received via the wireless interface or directly on the device. The overriding command may be compared against an electronic key of the device before the discharge control module stops preventing discharge of the electric stun device.

### BRIEF DESCRIPTION OF THE DRAWINGS

A more complete understanding of the present invention may be gained by reference to the following ‘Detailed description’ when taken in conjunction with the accompanying drawings wherein

FIG. 1 is an exemplary logical representation of device use in accordance with the teachings of the present invention;

FIG. 2 is a flow chart of an exemplary algorithm in accordance with the teachings of the present invention; and

FIG. 3 is an exemplary modular view of a stun device in accordance with the teachings of the present invention.

### DETAILED DESCRIPTION

The following description of the exemplary embodiments of the present invention refers to the accompanying drawings. The same reference numbers in different drawings identify the same or similar elements. The drawings are not drawn to scale. The following detailed description does not limit the invention. Instead, the scope of the invention is defined by the appended claims.

More than one electric stun devices within a given range are capable of networked communication (via Bluetooth, Wireless Local Area Network (WLAN), proprietary protocol, etc). The invention aims at minimizing the occasion by which a target of a stun device could receive more than one discharge. It does not, however, guarantee that it will never happen or that it cannot happen anymore when the present invention is used. In a first aspect, based on an attempt to reach a target being made or a target being reached by a first device, the stun component of the other devices in the given area can be controlled. In a second aspect, presence of a stun device of a given type in the given area controls the stun component of all or some of other devices in the given area (e.g., civil vs. law enforcement versions). For greater certainty, it should be added that otherwise identical devices may still have different type attributes.

In both aspects, the control of the stun component may mean, for instance, deactivating the device or deactivating the stun component of the device (e.g., no release and no discharge possible) or may also mean making the stun component electrically passive (release possible yet without current), etc.). It remains to be tested whether a plurality of stun components could divide a total current amongst the number of shot received by the target while being effective. If so, the present invention could be used to coordinate the current to be applied by each device (not necessarily even distribution). There could also be a possibility for the electric stun device user to override the control thereby, for example, reactivating full capacities, activating the electric current in the released stun component or increasing the total current (e.g., this can be useful if there are different targets in the area, if a first failed attempt, if a device is advertising a wrong device type, etc.).

In the context of the present invention, the term ‘discharge’ is used to describe the nominal action of the stun component on its target (e.g., continuous low current at high voltage, current in pulses of different natures, current=f(t), etc.). The focus of the invention is not on the electrical characteristics of the discharge itself but on controlling occurrence of the discharge. As such, the present invention does not focus on any of the needed electrical components of a stun device. The focus of the invention is control imposed on the stun component based on status information from other stun devices. The present invention can be phrased around a decision, considering the status information, indicating if it is proper to discharge the electric stun device. Other equivalent can of course exist without departing from the teachings of the present invention (e.g., applying a control on the stun component based on discharge status or type information of other devices, etc.).

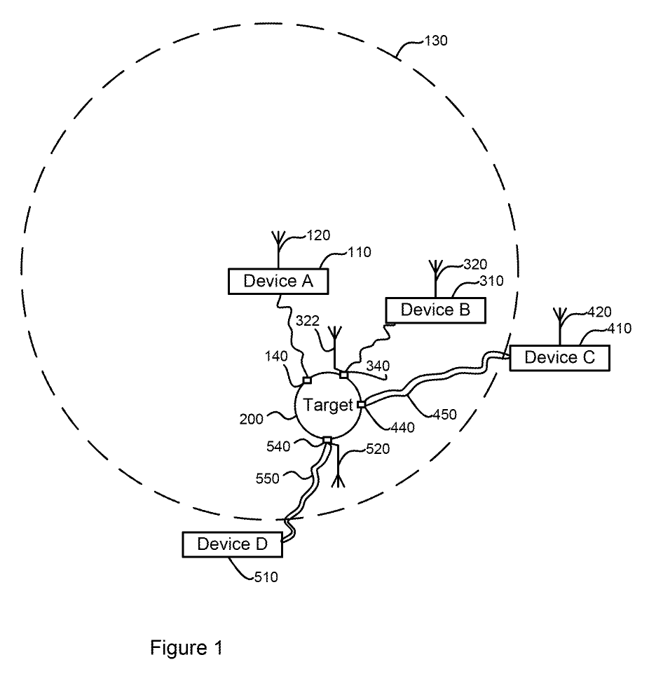

Reference is made to the drawings in which FIG. 1 shows an exemplary logical representation of device use in accordance with the teachings of the present invention. A stun device A 110 having a stun component 140 is shown as the central device on FIG. 1 to illustrate the present invention. Other perspectives could have been chosen. The device A 110 has wireless capabilities illustrated by an antenna 120. The antenna 120 is purely illustrative of wireless capabilities and does not limit the present invention to devices having an external antenna 120 as shown. The wireless capability's range of the device A 110 is shown by a dotted circle 130. The range 130 varies with specific technologies, characteristics of the receiving side, etc., and is purely illustrative on FIG. 1.

FIG. 1 also shows further devices B 310, C 410 and D 510. Each devices respectively has a stun component 340, 440, and 540 and wireless capabilities. The device B 310 has a pair of antennas 320 and 322 respectively on the device B 310 itself and on the stun component 340. This could enable a wireless communication between the device B 310 and its stun component 340 (e.g., for transmitting effectiveness of a given attempt to stun). The device C 410 has a single antenna 420 shown on the device C 410. A communication channel 450 is shown connecting the device C 410 with its stun component 440. The communication channel 450 can be a physical added wire (or set of wires) or could use the same wires used by the stun component (e.g., at a different frequency range, taking into account the electrical current used by the stun component). The communication channel 450 could be used to enable a communication between the device C 410 and its stun component 440. The device D 510 is shown with an antenna 520 on its stun component 540. A communication channel 550 is shown connecting the device D 510 with its stun component 540. The antenna 520 communicates with the device D 510 via the communication channel 550. Alternatively (or in addition), a second antenna on the device 510 (not shown) could be used (as for the device B 310) thereby providing either a backup wireless interface, a complementary interface (e.g., increased range) or a wireless communication channel between 540 and 510, etc.

A target 200 is also shown on FIG. 1. As a first option, the devices in a given area actively and continually locate and pair with each other. As such, each wireless capable device knows what other devices are present within their range before attempting to stun a target and coordinate therewith to make sure that known close device(s) have not already attempted to reach a target. There is usually a relatively long period of time that precedes a stun attempt (e.g., discussion before the target 200 is presumed uncontrollable without stun). This is a good period of time for each wireless capable device to assess what other device are present in the surrounding and pair together. As a second option, the device advertises its stun attempt post-facto and thereby enables listening devices to adjust their action. It is envisioned that Bluetooth® could be used as a short range low-cost technology to enable the present invention. The nominal 10 m (30′) range of action of the Bluetooth® is particularly good for the present context (e.g., given the nominal range of a stun device and the usual intervention range around a target). In terms of Bluetooth, the pairing is also a core feature of the protocol. Other protocols (including proprietary protocols crafted for specific aspects) could be used without departing from the teaching of the present invention.

For the purpose of the present example of FIG. 1, the device A 110 is capable of wireless communication with the device B 310 prior to attempting a reach of the target 200. The device C 410 and the device D 510 are, at the same instant, unreachable from A 110. It shall be assumed that the device A 110 is the first device that targets and tries to stun the target 200 (e.g., trigger pressed or other control button). As a first option, the device A 110 first inquires via its wireless capabilities 120 if other reachable devices have attempted to reach the target 200 (e.g., before releasing its stun component or between releasing the stun component and activation thereof on the target 200). If it receives status information indicating that no other device attempted a stun, it makes a decision to discharge its stun component 140. The device A 110 could also thereafter inform, via its wireless capabilities, other devices in its range of action of the discharge. As a second option, the device A 110 takes a decision to discharge its stun component 140 and thereafter informs, via its wireless capabilities, other devices in its range of action of the discharge (e.g., broadcast or peer-to-peer communication). The information, in the form of advertisement, could be sent once (upon decision) or periodically as long as the device A 110 is discharging.

For the purpose of the example of FIG. 1, no matter if option 1 or 2 is chosen, the device A 110 is the first to discharge its stun component 140. Thereafter, the device B 310 attempts a reach (e.g., trigger pressed). The device B 310 obtains status information from the device A 110 and, based thereon, takes a decision indicating that it is not proper to discharge its stun component 340. The decision prevents the discharge of the device B 310. The status information could be obtained after a request from the device B 310 (option 1 above) or from advertisement from the device A 110 (option 2 above).

Still after the device A 110 discharges its stun component 140, the device C 410 attempts a reach (or stun). In option 1 above, the device C 410 obtains status information from the device B 110 which could indicate that the device A has taken a decision to discharge and, based thereon, takes a decision indicating that it is not proper to discharge its stun component 440. The device B 110, however, could be configured not to report A's attempt (e.g., to limit the effective range of application of the present invention) and, therefore, the device C 410 could take a decision indicating that it is proper to discharge its stun component 440 and thereafter activate discharge of its stun component 440. In option 2, the status information from advertisement from the device A 110 (option 2 above) is not received and the device C 410 takes a decision indicating that it is proper to discharge its stun component 440 and thereafter activate discharge of its stun component 440.

Yet after the device A 110 discharges its stun component 140, the device D 510 attempts a reach (or stun). The device D 510 does not obtain status information from any device and therefore takes a decision indicating that it is proper to discharge its stun component 540. The device D 510, however, could be configured to keep requesting or listening to status information even after a first decision is taken. In such a case, the device D 510 obtains status information either from a reply by the device A 110 (option 1 above) or from advertisement from the device A 110 (option 2 above) and thereafter takes a decision indicating that it is not proper to discharge its stun component 540 and thereafter deactivate discharge of its stun component 540 (no matter if discharge was already taking place). Alternatively, a level of discharge could be negotiated via the wireless interface with the device A 110 (as discussed above).

In all examples above showing a decision indicating that it is not proper to discharge, an override command could be received (e.g., a second trigger pressing or another control button or series of action). Upon reception of the override command, a second decision indicating that it is proper to discharge is taken and the stun component is thereafter activated.

The status information exchanged between the devices could also indicate a device type or hierarchy of device. The status information could therefore be used to enable only a single device in an area (e.g., only activate the device used by the most experienced or graded agent) or to prevent other devices of a different type (e.g., civil version) from discharging. In such contexts, an override command could also be used, but may present more challenge (specific key information input) or different source for override command (e.g., a first device sends an activation sequence to a second device to override the second device meaning that a concerted action was undertaken before override).

Of course, a log of all or some actions can be taken by means known to those skilled in the art (electronic memory or all kinds).

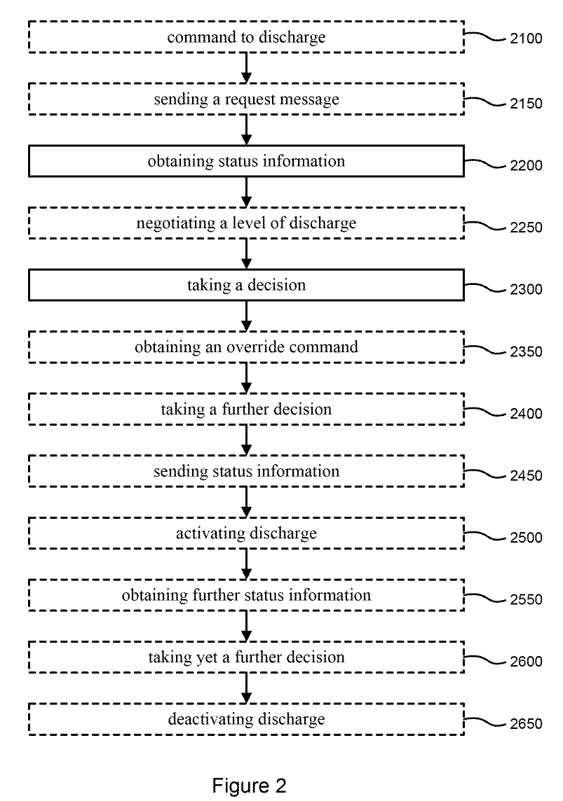

FIG. 2 shows a flow chart of an exemplary algorithm in accordance with the teachings of the present invention. On FIG. 2, optional steps are shown in dotted boxes to emphasis their optional nature dependent on the actual use of the present invention. The order in which the steps are shown is not necessarily important and rather represents an exemplary implementation of the invention.

A first optional step not shown on FIG. 2 is to have devices in a given range pairing with each other. The pairing step, as explained above, can be useful in identifying the devices from which status information can be used before the status information is actually needed to take a decision to discharge. However, it is optional as there are other ways of enhancing discharge decision making. A command to discharge an electric stun device can be received 2100. The command may come from a trigger or a further button of the electric stun device being pressed. It could eventually be a voice command (e.g., voice activated trigger) or could also come from a further wireless device that would send the command via the wireless interface of the electric stun device (e.g., trigger module in wireless communication with the stun component).

As exemplified above, it is possible for the electric stun device to send a request message 2150 for the status information to the neighboring devices (previously paired or not). The electric stun device could wait for a reply from all paired devices and/or wait for a reply within a specific period of time (e.g., ½ second) before considering that it received all replies it expected. It is possible that the electric stun device will determine that there is no status information to receive as the electric stun device is not within reach of a further device.

Thereafter, it can be said that the electric stun device obtained status information expected from the neighboring devices 2200. The status information may have been received prior to the command to discharge step 2100w without explicit request, may have been received via the request message of step 2150 or may simply indicate that no other device are within reach. In any case, the present invention is uses the status information received from at least a second electric stun device via its wireless interface. The status information may contain all kinds of information useful (or not) to the purpose of enhancing the discharge decision making of the electric stun device. It may comprise many or one of the following: the stun device's type (text, serial number, authoritative key, encryption key, etc.), discharge status (ready, recharging, discharging, discharged, etc.), past decision(s) (decision to discharge taken, decision not to discharge taken, decision to discharge at XYZ level taken, etc.), general actions (power-up, power-down, trigger pressed, trigger released, etc.), etc.

For example, if the status information received shows that a decision to discharge has already been taken, then a step of taking a decision indicating that it is not proper to discharge the electric stun device is performed (2300). Other events could be taken to mean the same (trigger pressed and discharging, etc.). If the status information shows that the second electric stun device is of a superseding type compared to the electric stun device's own type, then the step of taking the decision 2300 further comprises indicating that it is not proper to discharge the electric stun device.

The status information may also show that another electric stun device has taken an own decision to discharge which may then trigger a further step of negotiating a level of discharge 2250 with the other electric stun device via the wireless interface. Then, the step of taking the decision 2300 may further comprise indicating that it is proper to discharge the electric stun device at the negotiated level.

In all cases, the step of taking the decision 2300 is executed taking into consideration the status information and shall aim at indicating if it is proper to discharge the electric stun device. As the status information may be absent (no further device or no information yet received), it shall be said that a default decision in such situation could be to indicate that it is proper to discharge. Nevertheless, it could be decided that an electric stun device shall never be used alone and, in such cases, the default action could be to indicate that it is not proper to discharge.

In cases where the step of taking the decision 2300 comprises indicating that it is not proper to discharge the electric stun device, a further step of obtaining an override command 2350 may be performed. The command may be of a same type as the optional command 2100. An overriding command may also be, for instance, a specific key information input or the override command may come from a different source (e.g., a first device sends an activation sequence to a second device to override the second device meaning that a concerted action was undertaken before override), etc.

Once the override command is received and a step of taking a further decision 2450 may be performed. If the override command is deemed valid (based on criteria established on a use-case basis), then the decision should indicate that it is proper to discharge the electric stun device. If, for any reason, the override command is deemed invalid (again, based on criteria established on a use-case basis), then the decision should indicate that it is not proper to discharge the electric stun device

For all types of decisions, the electric stun device may then perform a step of sending status information via the wireless interface thereof 2450 indicating the decision to discharge (and/or any other information as mentioned earlier). The step of sending status information 2450 may represent a necessity if the decision indicates that it is proper to discharge and if the only way to affect other device's discharge decision process is by way of advertisement of status information (like 2450) rather then involving request messages (like 2150). The step of sending status information 2450 may also be performed to indicate that an attempted discharge has failed. This could be performed, for instance, after detecting a failure to properly discharge the electric stun device (not shown). The detection could be insured by any kind of interaction with a stun component of the electric stun device.

Following a decision indicating that it is proper to discharge the electric stun device, a step of activating discharge of the electric stun device is performed (2500). The steps 2500 and 2450 (if executed) may be inverted based on desired result. Furthermore, the details of the step 2500 are not mentioned here as the discharge should have usual characteristics (release characteristics and current activation timing and characteristics are outside the scope of the present invention). If the decision taken in 2300 indicates a level of discharge, such information is used at this point.

At any time in the sequence of FIG. 2, the electric stun device may obtain further status information. If the information is received while the device is discharging (or after a decision indicating that it is proper to discharge), then the further status information may have the effect of taking yet a further decision 2600 that indicates that it is not proper to discharge the electric stun device thereby causing deactivation of the discharge 2650 (e.g., status information indicates an ongoing discharge that was not unknown). On the other hand, If the information is received while the device is not discharging (or after a decision indicating that it is not proper to discharge), then the further status information may have the effect of taking yet a further decision 2600 that indicates that it is proper to discharge the electric stun device thereby causing the discharge to be activated (not shown, but similar to 2500) (e.g., status information indicates a failed attempt to discharge)

Further steps, not shown, that can be executed include detecting a malfunction of the electric stun device and based thereon, deactivating at least a discharge capability of the electric stun device without possibility of override by command as exemplified above. The override by command, in such cases, is seen as potentially harmful as the detected malfunction may indicate tampering or otherwise deactivation of the feature of the present invention or, more generally, of the electric stun component. Malfunction (due to tampering or not) may be detected following: detection of unscrewing the device open (e.g., unscrewing breaks a connector); unplugging the wireless network interface (e.g., connector broken, simple reconnection does not reconnect the broken connector and proper reconnection requires special procedure); receiving message(s) that are not authenticated using a manufacturer's mechanism (e.g., messages authenticated using the key also used to determined the device's type); the device's charger comprises a wireless interface wherein failure to communicate with the charger via the wireless interface (e.g., while the device is charging) indicates malfunction (or tampering—equally problematic) of the wireless interface. A key that determines the device's type could be input via a GUI on the charger. A single charger could be used to configure more than one device. Each device could have a unique identifier (e.g., such as a MAC address used in Ethernet). The charger could keep an association between the device identifier and the key and check for the match upon charging the device.

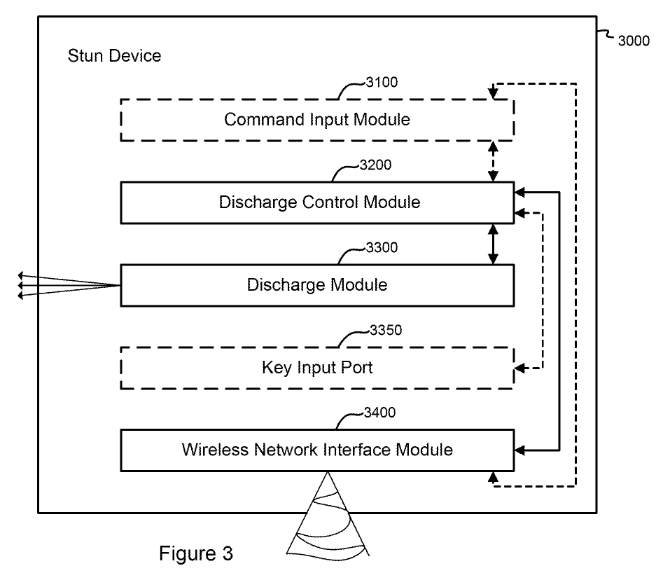

FIG. 3 shows an exemplary modular view of an electric stun device 3000 in accordance with the teachings of the present invention. The electric stun device 3000 comprises a wireless network interface 3400, a discharge module, 3300 and a discharge control module 3200. electric stun device 3000 may also comprise a command input module 3100. IN a first embodiment of the electric stun device 3000, the wireless network interface 3400 is capable of receiving status information from at least a second electric stun device. The discharge control module takes a decision, considering the status information, indicating if it is proper to discharge the electric stun device and the discharge module 3300 discharges the electric stun device based on the decision of the discharge control module.

The optional command input module 3100 may receives a command to discharge and sends the command to discharge to the discharge control module 3200 which takes the decision following reception of the command to discharge.

The discharge control module 3200 may further receive, before taking the decision, the status information from the wireless network interface indicating that at least one other electric stun device has taken an own decision to discharge. Then, the decision shall indicate that it is not proper to discharge the electric stun device. Following the decision indicating that it is not proper to discharge the electric stun device, the command input module 3100 may receive a second command to discharge. Once send to the discharge control module 3200, it causes a second decision to be taken indicating that it is proper to discharge the electric stun device.

The discharge control module 3200 may also further request the status information from other electric stun devices via the wireless interface upon reception of the command to discharge. Received status information via the wireless network interface is then taken in to consideration.

The discharge control module 3200 may also fail to receive, before taking the decision, any status information from the wireless network interface, in which case the decision shall indicate that it is proper to discharge the electric stun device. The wireless network interface 3400 is then further capable of sending status information (e.g., to other electric stun device) after the decision being taken by the discharge control module 3200.

The wireless network interface 3400 may also be further capable of pairing with other electric stun device and/or other devices used for managing the present invention or, more generally managing the electric stun device.

The status information received from other electric stun devices may indicate that at least one electric stun device is of an overriding type. The decision taken by the discharge control module 3200 shall then indicate that it is not proper to discharge the electric stun device.

In a second embodiment of the electric stun device 3000, the wireless network interface 3400 is capable of receiving authoritative information from at least another wireless device. The discharge control module 3200 receives the authoritative information from the wireless network interface and assesses whether the authoritative information indicates that the electric stun device 3000 is permitted to discharge. The discharge control module 3200 may assess whether the authoritative information indicates that the electric stun device is permitted to discharge by comparing a device type of the electric stun device with the received authoritative information. The device type information may be entered in the electric stun device 3000 before initial use of the device, using an electronic key, etc.

The electric stun device may also comprise an electronic key input port 3450 for receiving the electronic key's computer readable media. The electronic key may, alternatively or in addition, be entered in the electric stun device 3000 using the wireless interface 3400. Yet another alternative is to enter the electronic key using an interface port (not shown) also used to charge the device.

The discharge control module's 3200 assessment may also indicate that the electric stun device is not permitted to discharge, which causes the discharge control module 3200 to prevent discharge of the electric stun device. (e.g., the discharge control module 3200 prevents discharge by disabling a discharge module 3300).

The optional command input module 3100 may also receive an overriding command that causes the discharge control module 3200 to stop preventing discharge of the electric stun device. The overriding command may be received via the wireless interface 3200 or directly on the electric stun device 3000 (e.g., via the control input module 3100).

The overriding command may be compared against an electronic key of the electric stun device 3000 before the discharge control module 3200 stops preventing discharge of the electric stun device 3000.

In some instances, it may be useful to override the application of the decision making process for a longer period of time, specified based on the use case, (e.g., for an intervention in a crowd). This is equally applicable in the context of device's type comparison, but of particular interest in the context of decision making coordination.

Stick device (e.g., using fixed stun component such as electrodes), shooting device (e.g., using shootable stun component such as electrodes with or without darts), etc. can be used in the context of the present invention. The target can be a human or other higher life form.

The work performed by Claude Gauthier and Martin Kirouac (application numbers U.S. Ser. No. 11/843,966 and U.S. Ser. No. 11/949,359 herein incorporated by reference) could be helpful in enabling target identification based on the electric stun device's movement thereby enhancing the capabilities of the present invention by limiting its application on a target basis (i.e., if more than one target are identified, attempt shall be made, during the discharge decision making process, to consider the target information and not base the decision only on status information).

The foregoing description of exemplary embodiments of the present invention provides illustration and description, but it is not intended to be exhaustive or to limit the invention to the precise form disclosed. For example, the device's wireless interface shown on Figure X uses an omnidirectional antenna for illustrative purposes. The person skilled in the art will readily recognize that radio range depends on multiple factors in a real environment (e.g., type of antenna(s), obstacles, other electromagnetic fields, etc.). Using one or more directional antennas could be useful (e.g., based on expected use case). Likewise, the illustration of antenna as shown on Figure X is meant to be a logical representation of the wireless capacity of the device. While an external antenna could be used, the person skilled in the art will readily recognize that, in expected frequency bands and in view of current technologies, an external antenna is usually not necessary, especially on distances envisioned for the use of the present invention. Modifications and variations are possible in light of the above teachings or may be acquired from practice of the invention. The following claims and their equivalents define the scope of the invention.

What is claimed is:

1. A method for controlling discharge of an electric stun device that comprises steps of:
obtaining status information from at least a second electric stun device via a wireless interface of the electric stun device; and
taking a decision, considering the status information, indicating if it is proper to discharge the electric stun device.

2. The method of claim 1 wherein the step of obtaining status information further comprises obtaining status information showing that the second electric stun device has taken an own decision to discharge and wherein the step of taking the decision further comprises indicating that it is not proper to discharge the electric stun device.

3. The method of claim 2 further comprising steps of:
obtaining further status information from the at least a second electric stun device via a wireless interface of the electric stun device; and;
taking a further decision considering the further status information, indicating if it is proper to discharge the electric stun device.

4. The method of claim 1 wherein the step of obtaining status information further comprises obtaining status information showing that the second electric stun device has taken an own decision to discharge, the method comprising a further step of negotiating a level of discharge with the second electric stun device via the wireless interface, wherein the step of taking the decision further comprises indicating that it is proper to discharge the electric stun device at the negotiated level.

5. The method of claim 1 wherein the step of obtaining status information further comprises obtaining status information showing that the second electric stun device has taken an own decision to discharge, the method further comprising obtaining an override command prior to indicating that it is proper to discharge the electric stun device.

6. The method of claim 1 wherein the step of obtaining status information further comprises obtaining status information showing that the second electric stun device is of a superseding type compared to the electric stun device's own type and wherein the step of taking a decision further comprises indicating that it is not proper to discharge the electric stun device.

7. The method of claim 1 wherein the step of taking the decision further comprises indicating that it is proper to discharge the electric stun device, the method further comprising steps of:
sending status information from the electric stun device via the wireless interface thereof indicating the decision to discharge; and
thereafter, activating discharge of the electric stun device.

8. The method of claim 7 further comprising, following the step of activating discharge of the electric stun device, steps of:
detecting a failure to properly discharge the electric stun device; and
sending status information from the electric stun device via the wireless interface thereof indicating the discharge has failed.

9. The method of claim 1 further comprising a first step of pairing the electric stun device with the at least second electric stun device and a second step of detecting a command to discharge the electric stun device, wherein the step of obtaining status information from the at least second electric stun device via a wireless interface of the electric stun device comprises receiving the status information from the at least second electric stun device comprising the at least second electric stun device's type and discharge status.

10. The method of claim 9 wherein the step of receiving the status information is preceded by a step of sending a request message for the status information to the at least second electric stun device via the wireless interface.

11. The method of claim 1 further comprising steps of:
detecting a malfunction of the electric stun device; and
thereafter, deactivating at least a discharge capability of the electric stun device without possibility of override by command.

12. An electric stun device comprising:
a wireless network interface capable of:
receiving status information from at least a second electric stun device; and
a discharge control module that:
takes a decision, considering the status information, indicating if it is proper to discharge the electric stun device; and
a discharge module that
discharges the electric stun device based on the decision of the discharge control module.

13. The device of claim 12 further comprising a command input module that:
receives a command to discharge; and
sends the command to discharge to the discharge control module;
wherein the discharge control module takes the decision following reception of the command to discharge.

14. The device of claim 13 wherein the discharge control module further receives, before taking the decision, the status information from the wireless network interface indicating that at least one of the at least second electric stun device has taken an own decision to discharge, wherein the decision indicates that it is not proper to discharge the electric stun device.

15. The device of claim 14, wherein, following the decision, the command input module receives a second command to discharge and the discharge control module takes a second decision indicating that it is proper to discharge the electric stun device.

16. The device of claim 13 wherein the discharge control module further requests the status information from at least a second electric stun device via the wireless interface upon reception of the command to discharge and thereafter receives the status information from the wireless network interface.

17. The device of claim 13 wherein the discharge control module does not receive, before taking the decision, the status information from the wireless network interface, wherein the decision indicates that it is proper to discharge the electric stun device.

18. The device of claim 17 wherein the wireless network interface is further capable of sending status information to the at least second electric stun device after the decision being taken by the discharge control module.

19. The device of claim 12 wherein the wireless network interface is further capable of pairing with the at least second electric stun device.

20. The device of claim 12 wherein the status information received from at least the second electric stun device indicates that at least one of at least the second electric stun device is of an overriding type, wherein the decision indicates that it is not proper to discharge the electric stun device.

21. An electric stun device comprising:
a wireless network interface capable of:
receiving authoritative information from at least another wireless device; and
a discharge control module that:
receives the authoritative information from the wireless network interface;
assesses whether the authoritative information indicates that the electric stun device is permitted to discharge.

22. The device of claim 21 wherein the discharge control module assesses whether the authoritative information indicates that the electric stun device is permitted to discharge by comparing a device type of the electric stun device with the received authoritative information.

23. The device of claim 22 wherein the device type information is entered in the device before initial use of the device.

24. The device of claim 22 wherein the device type information is entered in the device using an electronic key.

25. The device of claim 24 further comprising an electronic key input port for receiving the electronic key's computer readable media.

26. The device of claim 24 wherein the electronic key is entered in the device using the wireless interface.

27. The device of claim 24 wherein the electronic key is entered in the device using an interface port also used to charge the device.

28. The device of claim 21 wherein the discharge control module's assessment indicates that the electric stun device is not permitted to discharge and wherein the discharge control module thereafter prevents discharge of the electric stun device.

29. The device of claim 27 wherein the discharge control module prevents discharge by disabling a discharge module.

30. The device of claim 28 further comprising a command input module that receives an overriding command that causes the discharge control module to stop preventing discharge of the electric stun device.

31. The device of claim 29 wherein the overriding command is received via the wireless interface or directly on the device.

32. The device of claim 29 wherein the overriding command is compared against an electronic key of the device before the discharge control module stops preventing discharge of the electric stun device.
